(19) United States
(12) Patent Application Publication
(10) Pub. No.: US 2002/0042768 A1
(43) Pub. Date: Apr. 11, 2002

(54) Method and apparatus for supporting transaction

(76) Inventors: Osamu Kurose, Tokyo (JP); Noriyuki Ochiai, Tokyo (JP)

Correspondence Address: STAAS & HALSEY LLP, 700 11TH STREET, NW, SUITE 500, WASHINGTON, DC, 20001, US

(21) Appl. No.: 09/780,435

(22) Filed: Feb. 12, 2001

(30) Foreign Application Priority Data
Oct. 6, 2000 (JP) 2000-308099

(51) Int. Cl. G06F 17/60; G06F 19/00

(52) U.S. Cl. 705/37; 700/106

(57) ABSTRACT

In a transaction support method and a transaction support apparatus for simply executing inquiries for a plurality of raw materials used to produce a finished product therefrom, when a predetermined finished product composed of a plurality of raw materials is designated by a client of a buyer, a finished product designating unit receives the designated finished product. A raw material referring unit obtains information as to raw materials constituting the designated finished product. A raw material classifying unit classifies the raw materials to respective sellers concerned. An inquiry unit makes inquiries to clients of buyers concerned based on a result of the classification executed by the raw material classifying unit. An auction unit determines conditions through an auction when a plurality of sellers are available for the same raw material. A transaction conditions obtaining unit obtains transaction conditions as a result of the auction executed by the auction unit or as a result of the inquiries made by the inquiry unit. A presentation unit integrates the transaction conditions of the respective sellers and presents the integrated transaction conditions to a client requesting them.

### BACKGROUND OF THE INVENTION

(1) Field of the Invention

The present invention relates to a method and an apparatus for supporting transactions, and more particularly to a method and an apparatus for supporting commodity transactions executed between a buyer and sellers through a network.

(2) Description of the Related Art

Hitherto, when a food provider such as a restaurant and the like places an order for food materials to a wholesaler and the like, the food provider makes a recipe for a commodity (food) as a finished product and places an order for each food material necessary to produce the food in the quantity which is obtained by multiplying the quantity of each food material described in the recipe by the number of sales of the finished product.

A similar case can be found when, for example, a pharmaceutical firm, a chemical firm and the like place an order for raw materials necessary to produce a finished product as a finally-produced material.

In the conventional method, however, a problem arises in that processing such as calculation and the like is complex because raw materials consituting a finished product must be specified from a recipe and the like and orders must be placed for the raw materials in the quantities which correspond to the forecast amount of sales of the finished product.

Further, the prices of food materials and the like are ordinarily fluctuated due to changes in demand and timings at which transactions are carried out. Conventionally, however, transactions are ordinarily performed with specific dealers continuously, from which a problem arises in that it is not apparent whether or not the raw materials and conditions of the raw materials presented by the present dealers are optimum.

### SUMMARY OF THE INVENTION

Accordingly, it is an object of the present invention to provide a transaction support method capable of simply placing an order for raw materials used to produce a finished product.

Another object of the present invention is to provide a transaction support apparatus that permits transactions to be carried out with optimum dealers regardless of changes in demand and timings at which the transactions are carried out.

To achieve the above objects, a transaction support method on a server side is provided to support commodity transactions executed between a buyer and sellers through a network. The transaction support method includes a finished product designating step for receiving the designation of a finished product from the buyer; a raw material referring step for obtaining information as to raw materials constituting the finished product based on information as to the finished product and information as to the raw materials constituting the finished product with respect to the finished product designated at the finished product designating step; an inquiry step for making inquiries to the sellers about the raw materials obtained at the raw material referring step; and a presenting step for presenting a result of the inquiry executed at the inquiry step to the sellers.

Further, to achieve the above objects, a transaction support apparatus is provided to support commodity transactions executed between a buyer and sellers through a network. The transaction support apparatus includes a finished product designating unit for receiving the designation of a finished product from the buyer; a raw material referring unit for obtaining information as to raw materials constituting the finished product based on information as to the finished product and the raw materials constituting the finished product in regard to the finished product designated by the finished product designating unit; an inquiry unit for making inquiries to the sellers about the raw materials obtained by the raw material referring unit; and a presentation unit for presenting a result of the inquiry executed by the inquiry unit to the sellers.

The above and other objects, features and advantages of the present invention will become apparent from the following description when taken in conjunction with the accompanying drawings which illustrate preferred embodiments of the present invention by way of example.

### BRIEF DESCRIPTION OF THE DRAWINGS

FIG. 1 is a view explaining a principle based on which the present invention is operated;

FIG. 2 is a block diagram showing an arrangement of an embodiment of the present invention by way of example;

FIG. 3 shows an example of a table in which information as to a buyer is registered;

FIG. 4 shows a screen through which food materials are input by way of example;

FIG. 5 shows an example in which an addition button is pressed on a screen shown in FIG. 4;

FIG. 6 shows an example in which a details button is pressed on a screen shown in FIG. 5;

FIG. 7 is a view showing items set on a screen shown in FIG. 6 by way of example;

FIG. 8 is a view showing an example of a screen displayed as a result of simulation;

FIG. 9 is a view showing an example of transaction information in the past;

FIG. 10 is a view showing an example of data stored in a HDD of a transaction support apparatus;

FIG. 11 is a view showing an example of a food material table on which a plurality of recipes are integrated;

FIG. 12 is a view showing an example of a food material classification table which illustrates a relationship between names of food materials and food material classification;

FIG. 13 shows an example of a table in which information as to sellers is registered;

FIG. 14 is a view showing a message for prompting to participate in a buyer-driven auction by way of example;

FIG. 15 is a view showing a screen of the buyer-driven auction by way of example;

FIG. 16 is a view of an example of a bid screen which is shown when a bid button is pressed in FIG. 15;

FIG. 17 is view showing an example of a screen to which the input content of the screen shown in FIG. 16 is reflected;

FIG. 18 is a view showing an example of an electronic mail notifying buyers that a buyer-driven auction is finished;

FIG. 19 is a view showing an example of a screen on which a result of the buyer-driven auction is shown;

FIG. 20 is a view showing an example of a screen which is displayed when other dealer's quotation button is pressed on the screen shown in FIG. 19;

FIG. 21 is a view showing an example of the screen shown in FIG. 20 which corresponds to a case in which a second seller is selected;

FIG. 22 is a view showing an example of an electronic mail transmitted to sellers when an order button is pressed on the screen of FIG. 21;

FIG. 23 is a flowchart explaining an example of processing executed when a food material is inquired;

FIG. 24 is a flowchart explaining an example of processing executed when an electronic mail is transmitted to prompt sellers to participate in a buyer-driven auction;

FIG. 25 is a flowchart explaining an example of processing executed in the buyer-driven auction; and

FIG. 26 is a flowchart explaining an example of processing executed when the buyer-driven auction is finished.

### DESCRIPTION OF THE PREFERRED EMBODIMENTS

An embodiment of the present invention will be described below with reference to the drawings.

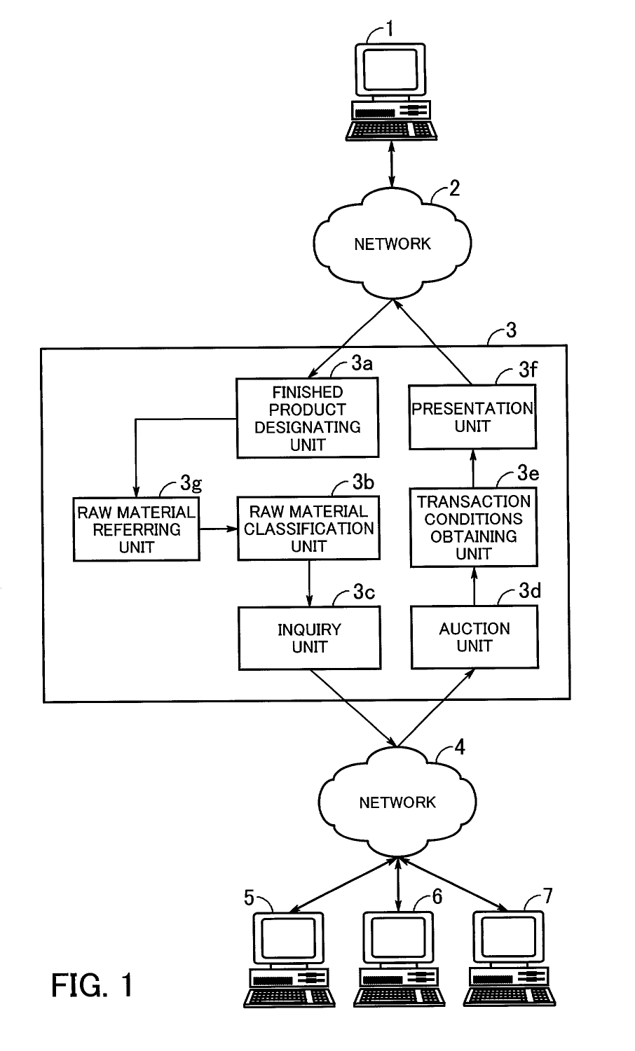

FIG. 1 is a view explaining a principle based on which the present invention is operated. As shown in FIG. 1, a transaction support apparatus 3 according to a transaction support method of the present invention includes a finished product designating unit 3a, a raw material classification unit 3b, an inquiry unit 3c, an auction unit 3d, a transaction conditions obtaining unit 3e, a presentation unit 3f, and a raw material referring unit 3g. The transaction support apparatus 3 is connected to the client 1 of a buyer through a network 2 as well as connected to clients 5-7 of sellers through a network 4.

The finished product designating unit 3a designates a predetermined finished product composed of a plurality of raw materials.

The raw material referring unit 3g obtains information as to raw materials constituting the finished product based on information as to the finished product and information as to the raw materials constituting the finished product with respect to the finished product designated by the finished product designating unit 3a.

The raw material classification unit 3b classifies the plurality of raw materials specified by the raw material reference unit 3g to respective sellers concerned.

The inquiry unit 3c makes inquiries for the respective raw materials to sellers concerned in accordance with a result of the classification made by the raw material classification unit 3b.

When a plurality of sellers are available to a predetermined raw material, the auction unit 3d determines transaction conditions by an auction.

The transaction conditions obtaining unit 3e obtains transaction conditions obtained as a result of the inquiries made by the inquiry unit 3c or as a result of the auction executed by the auction unit 3d.

The presentation unit 3f integrates the transaction conditions of the respective sellers obtained by the transaction conditions obtaining unit 3e and presents the transaction conditions to the sellers.

Next, an operation of the present invention will be described with reference to FIG. 1 showing the principle of operation of the present invention.

A case in which an order is placed for raw materials for producing “adzuki-bean soup” as a finished product will be examined.

When, for example, the “adzuki-bean soup” is input as the finished product and “100 portions” are input as an amount of transaction by operating the client 1 of the buyer, this information is transmitted to the transaction support apparatus 3 through the network 2.

The finished product designating unit 3a of the transaction support apparatus 3 obtains this information, recognizes that the “adzuki-bean soup” and “100 portions” have been designated as the finished product and notifies this information to the raw material referring unit 3g.

The raw material referring unit 3g specifies “adzuki-bean”, “sugar”, “starch syrup”, and “refined rice flour” which are raw materials for producing the “adzuki-bean soup” as the finished product notified from the finished product designating unit 3a.

The raw material classification unit 3b classifies the raw materials to respective dealers concerned that handle the raw materials. For example, the “adzuki-bean” and the “refined rice flour” are classified to a dealer A which handles grain, and the “sugar” and the “starch syrup” are classified to dealers B and C which handle sweetener.

Next, the inquiry unit 3c makes an inquiry for 100 portions of “adzuki-bean” and “refined rice flour” to the client 5 of the dealer A. Similarly, the inquiry unit 3c makes an inquiry for 100 portions of “sugar” and “starch syrup” to the client 6 of the dealer B and to the client 7 of the dealer C.

An auction is executed by the auction unit 3d for the “sugar” and “starch syrup” because the plurality of dealers are available for these items, whereas, as to the “adzuki-bean” and the “refined rice flour”, the result of the inquiry is obtained as it is by the transaction conditions obtaining unit 3e.

The auction unit 3d selects more advantageous transaction conditions from the transaction conditions input from the clients 6 and 7.

The transaction conditions obtaining unit 3e supplies the result of the auction executed by the auction unit 3d and the result of the inquiry made by the inquiry unit 3c to the presentation unit 3f.

The presentation unit 3f integrates the transaction conditions obtained by the transaction conditions obtaining unit 3e, calculates the unit price of the finished product, and transmits the unit price to the client 1 of the buyer.

As a result, when the buyer is satisfied with the transaction conditions, the buyer can conclude a contract through a means such as a phone, an electronic mail and the like.

As described above, according to the transaction support apparatus 3 of the present invention, raw materials corresponding to a finished product are specified by designating the finished product and classified to sellers concerned, and then orders for the raw materials are placed to the sellers concerned, which can omit a time-consuming job for specifying the raw materials referring to a recipe and the like and for calculating the necessary amounts of the raw materials.

Further, when a plurality of sellers are available for the same raw material, it is possible to select a best dealer by an auction and to trade under transaction conditions which are more preferable to the buyer by introducing a principle of competition.

Next, an arrangement of the embodiment of the present invention will be described.

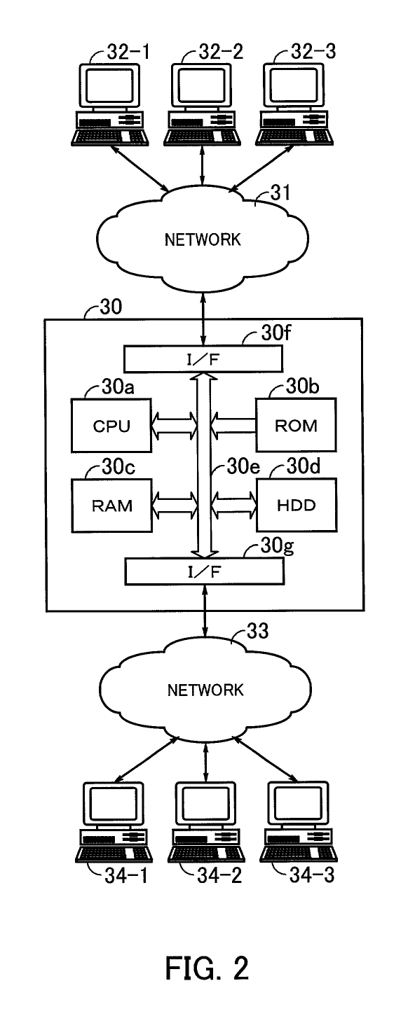

FIG. 2 is a block diagram showing the arrangement of the embodiment of the present invention by way of example. As shown in FIG. 2, a transaction support apparatus 30 according to the present invention is connected to the clients 32-1 to 32-3 of buyers through a network 31. Further, the transaction support apparatus 30 is connected to the clients 34-1 to 34-3 of sellers through a network 33 similarly.

The transaction support apparatus 30 is composed of a central processing unit (CPU) 30a, a read only memory (ROM)30b, a random access memory (RAM) 30c, a hard disk drive (HDD)30d, a bus 30e, and interfaces (I/Fs) 30f and 30g.

The CPU 30a executes various kinds of arithmetic processing according to programs stored in the HDD 30d as well as controls the respective components of the apparatus.

The ROM 30b stores basic programs, which are executed by the CPU 30a, and basic data.

The RAM 30c temporarily stores programs which are being executed by the CPU 30a and data which is being calculated thereby.

The HDD 30d stores programs to be executed by the CPU 30a as well as stores various kinds of data as to transaction.

The bus 30e interconnects the CPU 30a, the ROM 30b, the RAM 30c, the HDD 30d, and the I/Fs 30f and 30g so that data can be transmitted and received therebetween.

Each of the networks 31 and 33 is composed of, for example, the Internet.

Each of the clients 32-1 to 32-3 of the buyers is composed of, for example, a personal computer and can access the transaction support apparatus 30 and transmit and receive information to and from the transaction support apparatus 30 by executing an application program called a browser.

Note that the clients 34-1 to 34-3 of the sellers also are arranged in the same way.

Next, an operation of the above-mentioned embodiment will be described.

First, both buyers and sellers must register membership to get the benefits of the service presented by the transaction support apparatus 30. The membership can be registered in the browser by accessing the transaction support apparatus 30 or by transmitting information for required items to the transaction support apparatus 30 through an electronic mail.

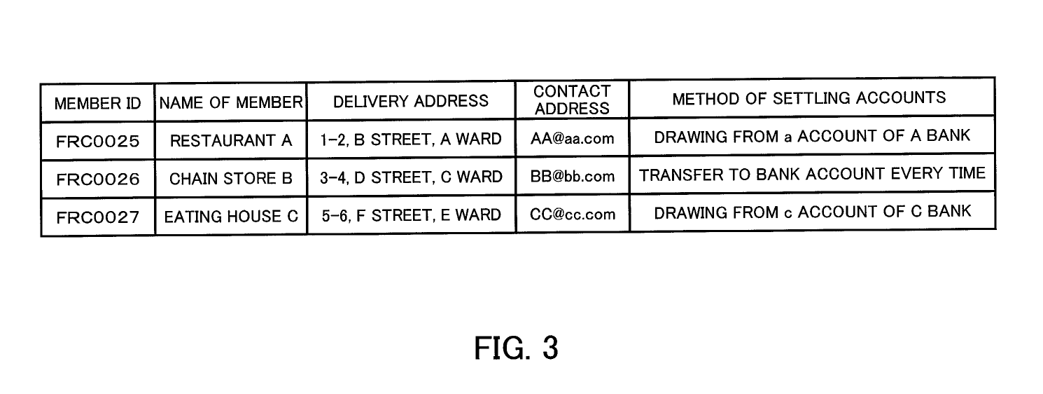

On the completion of the registration of the membership, the data shown in FIG. 3 is registered in the HDD 30d as to the buyers. In the example, a “member ID”,a “name of member”, a “delivery address”, a “contact address” and a “method of settling accounts” are registered as the data. Note that information such as a password and the like also are registered as necessary in addition to the above data.

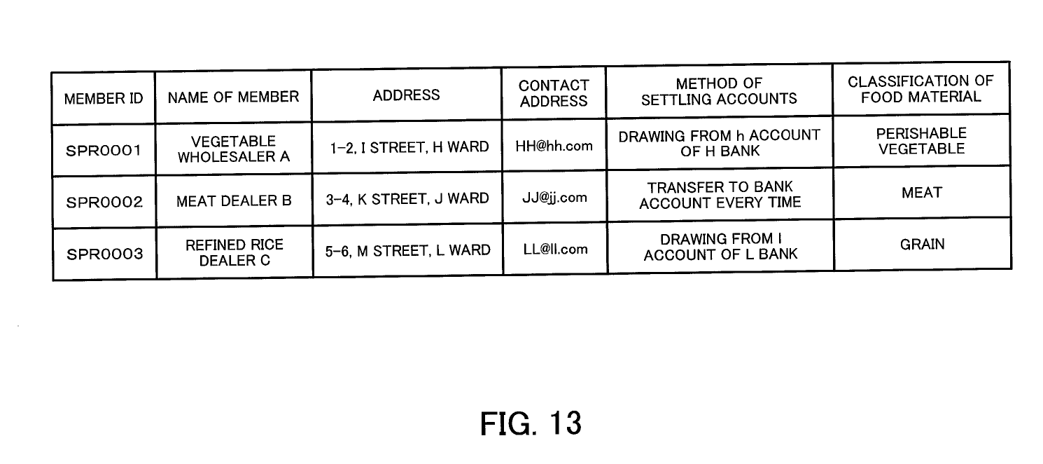

In contrast, information shown in FIG. 13 which will be described later is registered as to the seller. In the example, a “member ID”, a “name of member”, an “address”, a “contact address”, a “method of settling accounts”, and a “classification of food material” are registered.

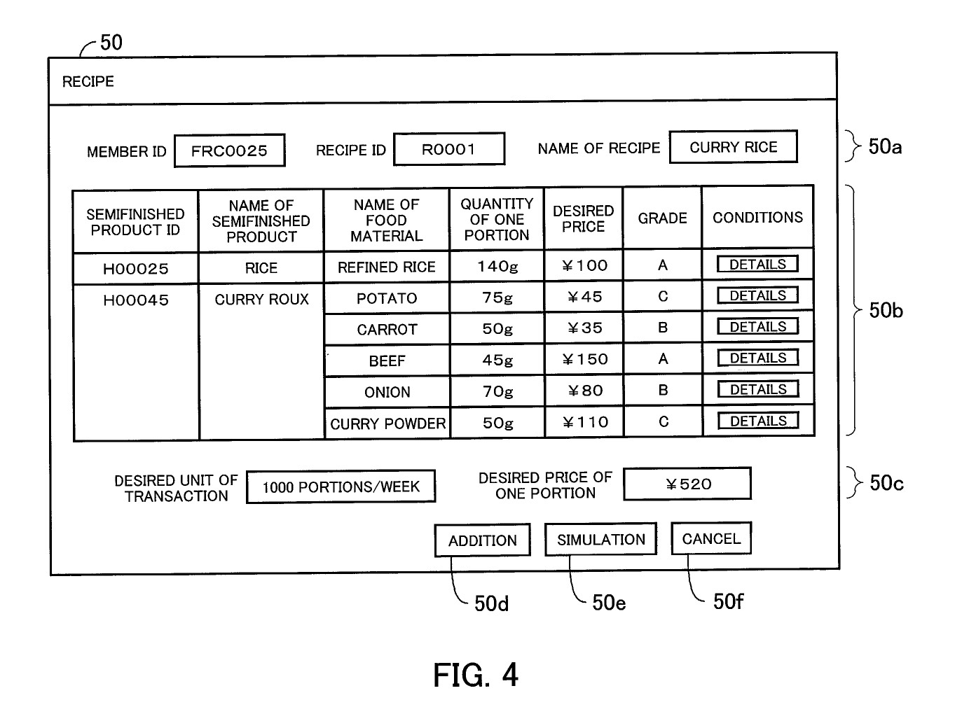

When a buyer having a member ID “FRC0025” operates the client 32-1 for the purpose of placing an order for food materials used to produce curry rice and accesses the transaction support apparatus 30, the transaction support apparatus 30 executes authentication processing by comparing the member ID with the information of FIG. 3 stored in the HDD 30d and confirms that buyer is an authorized user, and thereafter displays a screen 50 shown in FIG. 4 on the display device of the client 32-1.

When the buyer inputs a recipe ID (which is given by the buyer to manage a recipe) to the text box of a “recipe ID” on the displayed screen and then inputs the name of a target food “curry rice” to the text box of a “name of recipe”, the CPU 30a searches a list of the recipes stored in the HDD 30d, obtains a recipe corresponding to the “curry rice” and displays the recipe in a region 50b of the screen 50. In the displayed example, raw materials roughly classified to “rice” and “curry roux” are displayed as semifinished products. “Potato”, “carrot”, “beef”, “onion”, and “curry powder”, for example, are displayed as food materials for the curry roux as well as an amount of each raw material for one portion is displayed. A “desired price” and a “grade” are items that can be optionally set by the buyer, and the desired price means a price at which the buyer desires to buy a food material, and the grade means a grade of a food material (grade based on, for example, Japanese Agricultural Standards (JAS). Note that “conditions” on the right end of the screen 50 will be described later.

It should be noted that when a new recipe which is not yet registered is input, a recipe ID is automatically set to the recipe so that the recipe and the names of raw materials for the recipe can be input.

A text box for inputting a “desired unit of transaction” and a “desired price of one portion” are displayed in a region 50c. The “desired unit of transaction” means a unit for carrying out a transaction for a predetermined period of time and “1000 portions/week” is input as the “desired unit of transaction” in the example. Further, the “desired price of one portion” means the total price of the respective raw materials which are input in the region 50b and indicates a desired price of one portion.

An addition button 50d at the bottom of the screen is a button which is pressed when a raw material shown in the region 50b is added. A simulation button 50e is a button which is pressed to simulate forecast transaction conditions by comparing transaction conditions having been input with the actual records of past transaction conditions. A cancel button 50f is pressed when an input content is to be cancelled.

It should be noted that the food materials displayed using the name of the food having been input to the text box of the “name of recipe” as a keyword are only an example and the food materials must be changed in accordance with an object of the buyer. In that case, a change of, for example, quantity can be coped with by changing the contents displayed in the region 50b.

Further, when a new food material is to be added, first, a semifinished product corresponding to the new food material is designated (for example, the curry roux is designated), and thereafter the above-mentioned addition button 50d is pressed so as to display a column in which the new food material is to be written. Further, a food material can be deleted by pressing a “delete key” disposed on a keyboard after designating an item corresponding to the food material to be deleted.

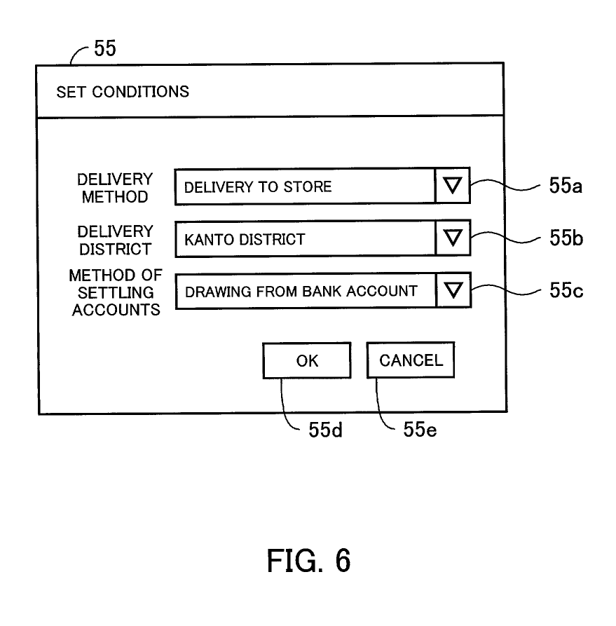

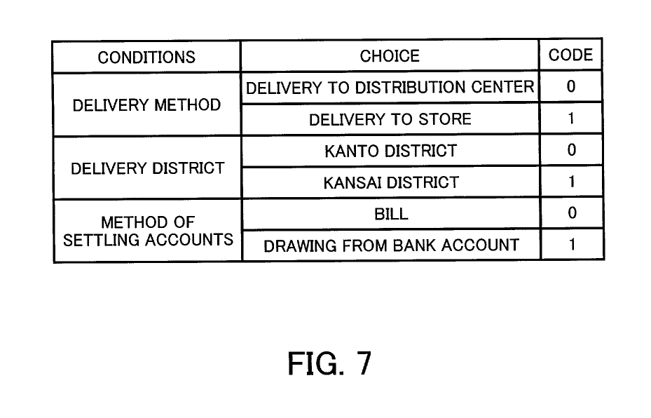

Incidentally, it is possible to set detailed conditions in transaction by pressing details buttons displayed in the column of “conditions” of the region 50b. When any of the details buttons is pressed, a screen 55 shown in FIG. 6 is displayed. In the screen 55, a “delivery method”, a “delivery district” and a “method of settling accounts” can be selected by selecting a desired item from a pull-down menu which is displayed by pressing the buttons displayed at the right ends of text boxes 55a to 55c. FIG. 7 shows an example of detailed items having been selected. As shown in FIG. 7, any of “delivery to distribution center” and “delivery to store” can be selected as a “delivery method”. Further, a “Kanto district” and a “Kansai district” can be selected as the “delivery district”. Further, any of a “bill” and “drawing from bank account” can be selected as the “method of settling accounts”. Note that the codes at the right end of FIG. 7 show information that indicates which one is selected in each of the “delivery method”, the “delivery district” and the “method of settling accounts”, and data composed of 3-bit codes indicates the “delivery method”, the “delivery district” and the “method of settling accounts” in this order. For example, when the “delivery to distribution center”, the “Kansai district” and the “drawing from bank account” are selected, this combination is indicated by data “011”.

Next, when the simulation button 50e is pressed after data is input to the items shown in FIG. 4, the CPU 30a obtains the information input by the client 32-1 and breaks down the information to respective food materials, and then calculates the forecast prices of the food materials by comparing the food materials with the past transaction records of them stored in the HDD 30d.

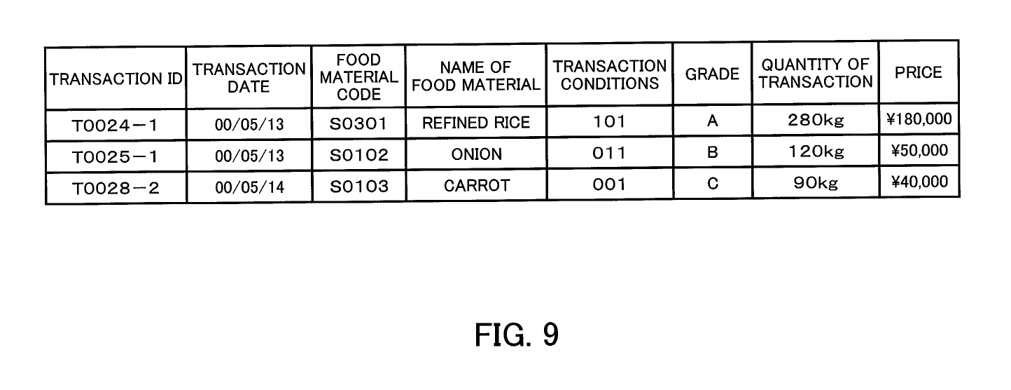

FIG. 9 shows an example of the past transaction records stored in the HDD 30d. A “transaction ID”, a “transaction date”, a “food material code”, a “name of food material”, a “transaction conditions”, a “grade”, a “quantity of transaction” and a “price” are shown in the example. For example, when the price of “refined rice” is to be forecast, the transaction conditions of the refined rice are set to “101”, the grade of the rice is set to “A”, the quantity thereof for one portion is 140g, and the desired unit of transaction thereof is 1000 portions/week, from which it is calculated that the price of the refined rice for one portion is “¥90” as described blow. That is, the quantity of transaction of the refined rice per week is 140kg and the price of the refined rice having the same conditions in FIG. 9 is “¥180,000” per 280kg, and thus the above price “¥90” is obtained by dividing ¥180,000 by 2,000 (280 kg/140 g).

It should be noted that when the past transaction data is not available, the forecast price is shown as “nil” to prevent the presentation of erroneous information to the buyer. Further, since prices of food materials such as vegetables and the like fluctuates depending upon a season, the prices of the vegetables may be forecast from the graphs showing the prices of them that change over time.

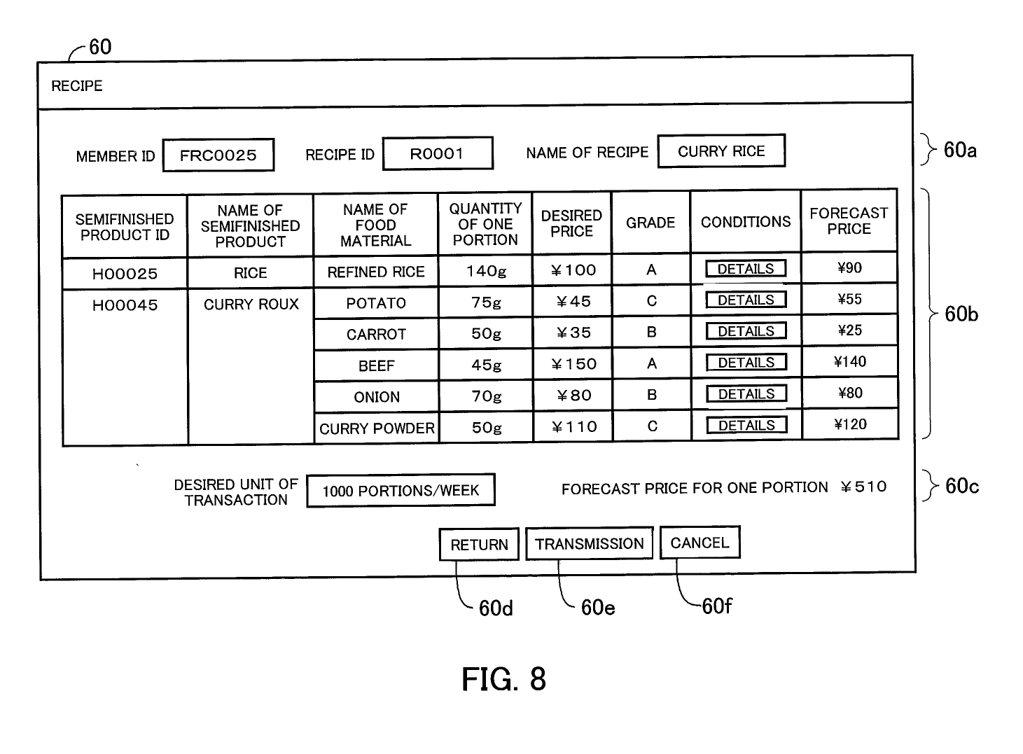

On the completion of the simulation as mentioned above, a screen 60 shown in FIG. 8 is displayed on the display device of the client 32-1. In the screen 60, the “forecast price” of the respective food materials calculated by the simulation are shown at the right ends of a region 60b, and a “forecast price for one portion” which is obtained by adding the forecast prices of all the food materials is shown in a region 60c. When the “forecast price for one portion” does not satisfy required conditions, the buyer can set the “forecast price for one portion” again by returning to the screen 50 of FIG. 4 by pressing a return button 60d and by performing the simulation again while changing a grade and the like.

When the result of the simulation satisfies the required conditions, the buyer can transmit the data of the food materials having been input to the transaction support apparatus 30 by pressing a transmission button 60e and puts the food materials up to a buyer-driven auction.

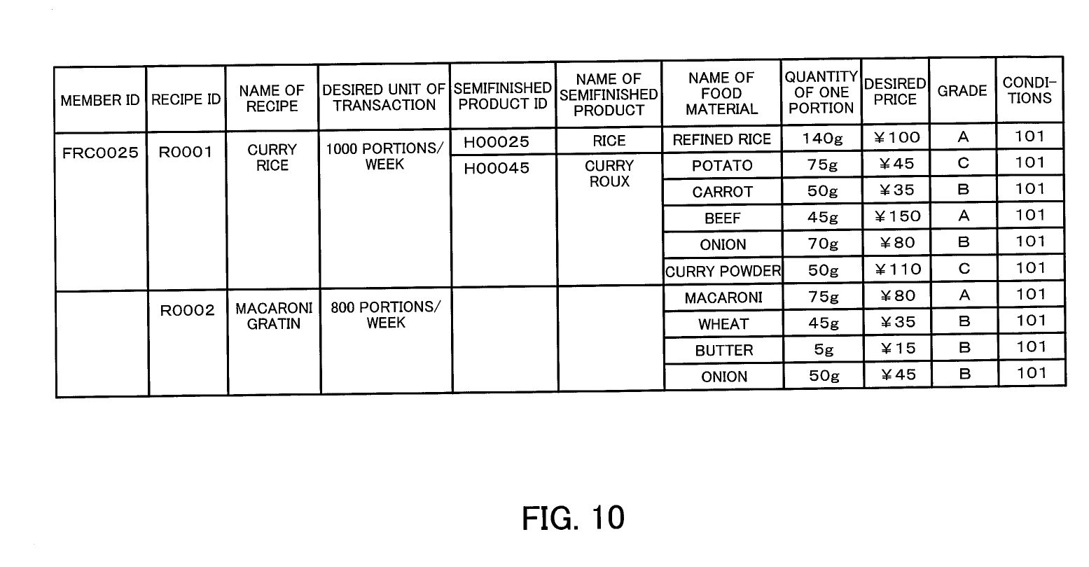

FIG. 10 is a view showing an example of the data transmitted from the client 32-1 and stored in the HDD 30d of the transaction support apparatus 30. In the example, data of food materials for “macaroni gratin” also is stored in addition to the data of the food material for the “curry rice” having been input on the screen 50 of FIG. 4. In many cases, an order is generally placed for food materials used in a plurality of foods by one operation. In that case, operations are repeated on the screens 50 and 60 shown in FIGS. 4 and 8 and data created by the operations is transmitted to the transaction support apparatus 30.

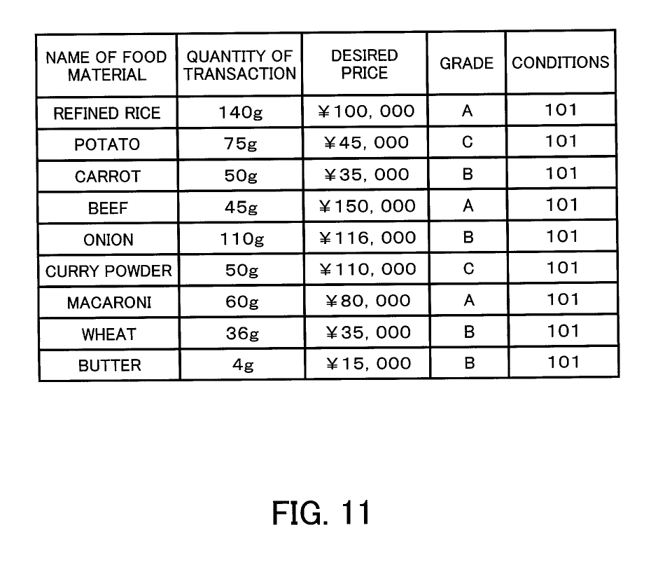

The transaction support apparatus 30 creates a food material table as shown in FIG. 11, which is utilized when an order is placed, by summarizing the data of the food materials received thereby. In FIG. 11, an item “name of food material” shows the name of each food material, an item “quantity of transaction” shows a value calculated from the desired unit of transaction shown in FIG. 10 and the quantity of each food material for one portion, an item “desired price” shows a value calculated from the desired unit of transaction shown in FIG. 10 and the desired price of each food material for one portion, and items “grade” and “conditions” show the data shown in FIG. 10 as it is. Note that the food material “onion” is included in both carry rice and macaroni gratin in FIG. 10 and they have the same “grade” and the “conditions”. Thus, they are integrated with each other and arranged as one data as shown in FIG. 11.

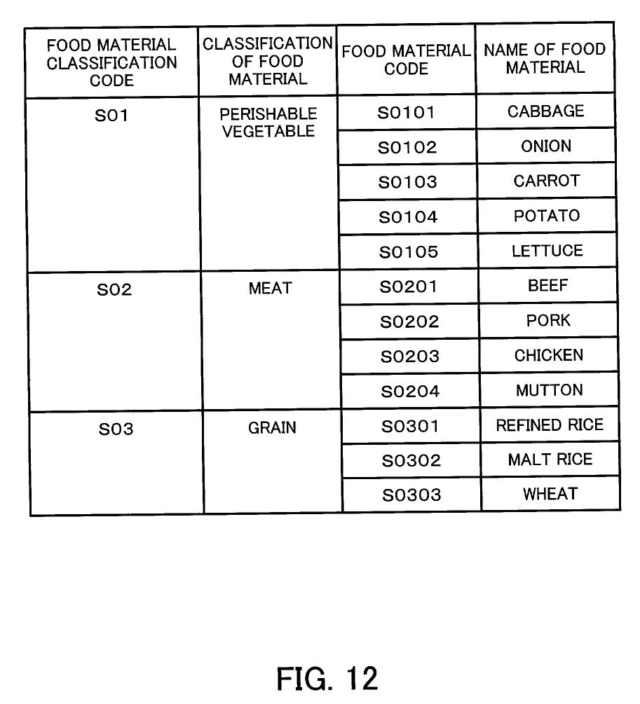

Subsequently, the transaction support apparatus 30 obtains the name of each food material from the food material table and specifies the classification of each food material referring to a food material classification table shown in FIG. 12. For example, when the name of a food material is “refined rice”, it can be found from the food material classification table that the “refined rice” is classified in “grain”.

When the food materials are classified as described above, the transaction support apparatus 30 next specifies sellers of each food material referring to a seller table shown in FIG. 13. For example, in the case of “refined rice”, since it is classified in “grain”, “refined rice dealer C” on the third row of the table in FIG. 13 is specified as a seller with which an order is to be placed. It should be noted that a plurality of members are actually registered while only three members are registered in the example and that a plurality of competitors are registered for food materials classified in the same category.

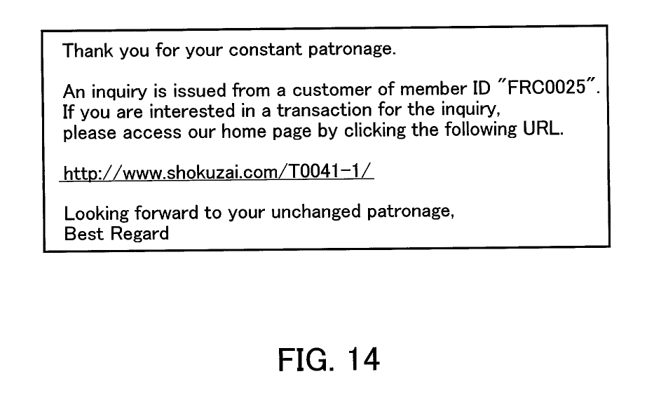

Subsequently, the transaction support apparatus 30 creates an electronic mail as shown in FIG. 14 for prompting sellers, which are specified for each food material and with which an order may be placed, to a buyer-driven auction and transmits the electronic mail to the sellers. For example, as to “refined rice”, an electronic mail, to which the URL of the home page of the buyer-driven auction for “refined rice” “http//www. shokuzai.com/t0041-1/” is attached, is transmitted to “refined rice dealer C” and other competitors.

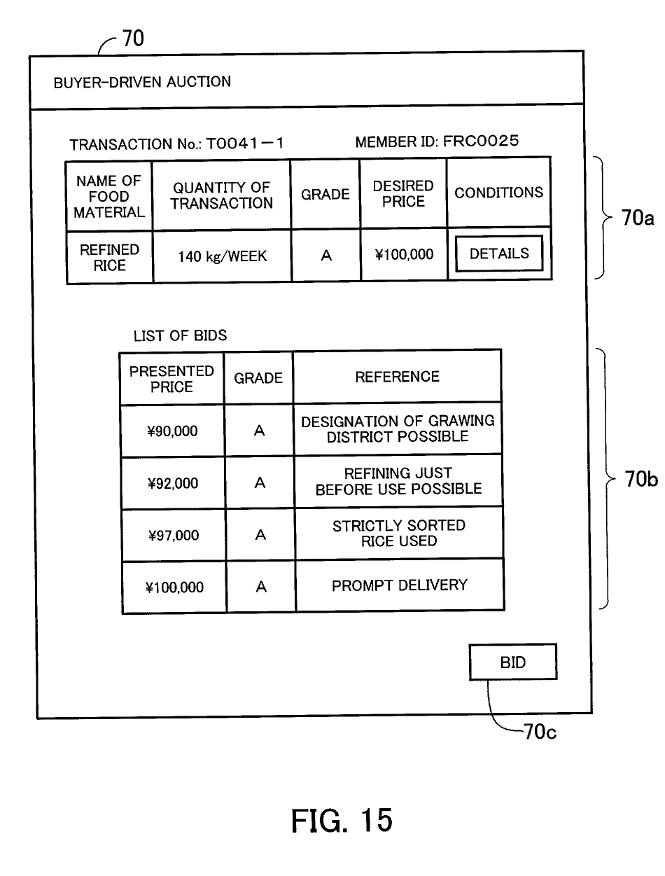

When a seller receives the electronic mail through, for example, the client 34-1 thereof and clicks the URL attached to the electronic mail, a screen 70 shown in FIG. 15 is displayed on the display device of the client.

The name of a food material which is to be put up on the buyer-driven auction, a quantity of transaction, a grade, a desired price and conditions are shown in the region 70a of the screen 70. Note that, as to the conditions, detailed transaction conditions can be referred to by pressing a details button.

When a bid is being carried out at the time of access, prices presented by bidders, grades, and references are shown in the region 70b of the screen 70 in order of increasing price. In the example, a bid which presents a price of “¥90,000” is displayed first.

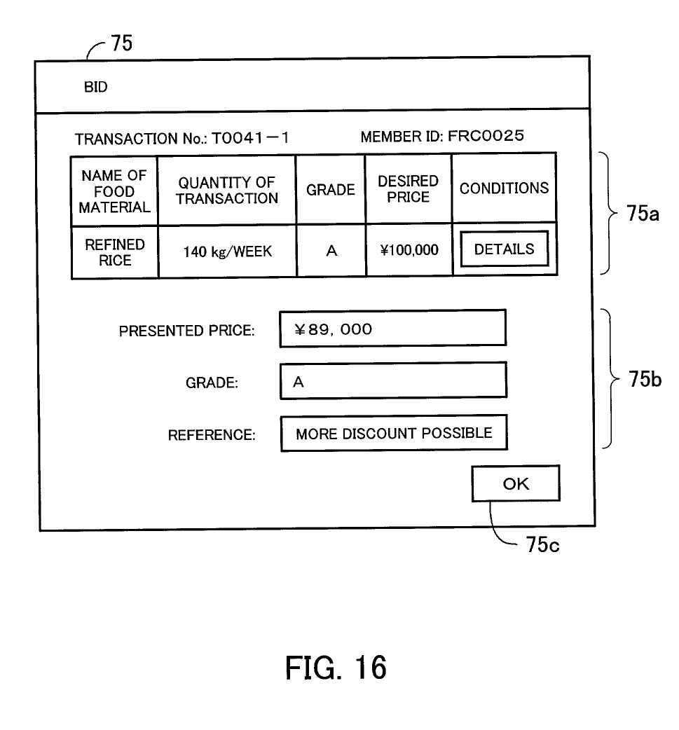

When a seller intends to offer a bid with reference to the screen 70, the seller presses a bid button 70C. As a result, a screen 75 as shown in FIG. 16 is shown on the display device of the seller. The name of a food material as a subject of transaction, and the like are displayed in the region 75a of the screen 75, and text boxes, in which a presented price, a grade, and reference are to be input, are displayed in the region 75b of the screen 75. In the screen 75, when the seller inputs data of necessary items and then presses an OK button 75c, the input information is transmitted to the transaction support apparatus 30 and registered in the HDD 30d so that the information is reflected to the buyer-driven auction.

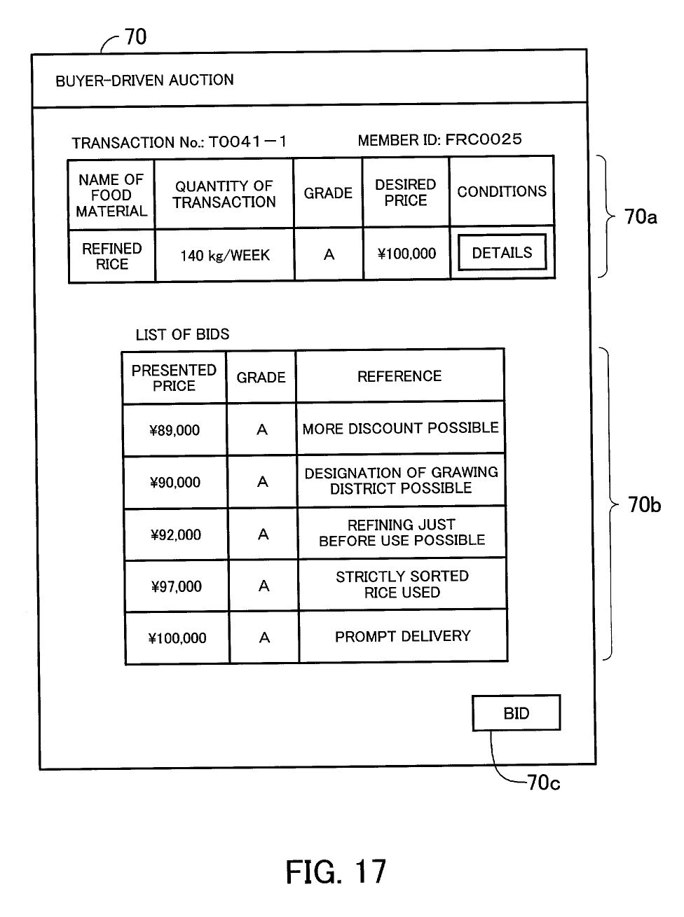

FIG. 17 shows an example of the screen 70 in which the content of the bid shown in FIG. 16 is reflected. In the example, the content of the bid which was input on the bid screen shown in FIG. 16 is displayed first in the region 70b.

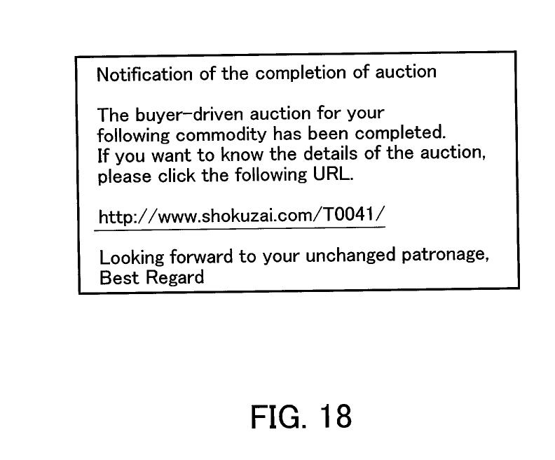

It should be noted that this buyer-drive auction is carried out for each food material for a predetermined period of time and then the price of each food material is determined. When the predetermined period of time passes, the transaction support apparatus 30 creates an electronic mail shown in FIG. 18 and notifies the sellers that the auction has been finished by transmitting the electronic mail to the sellers.

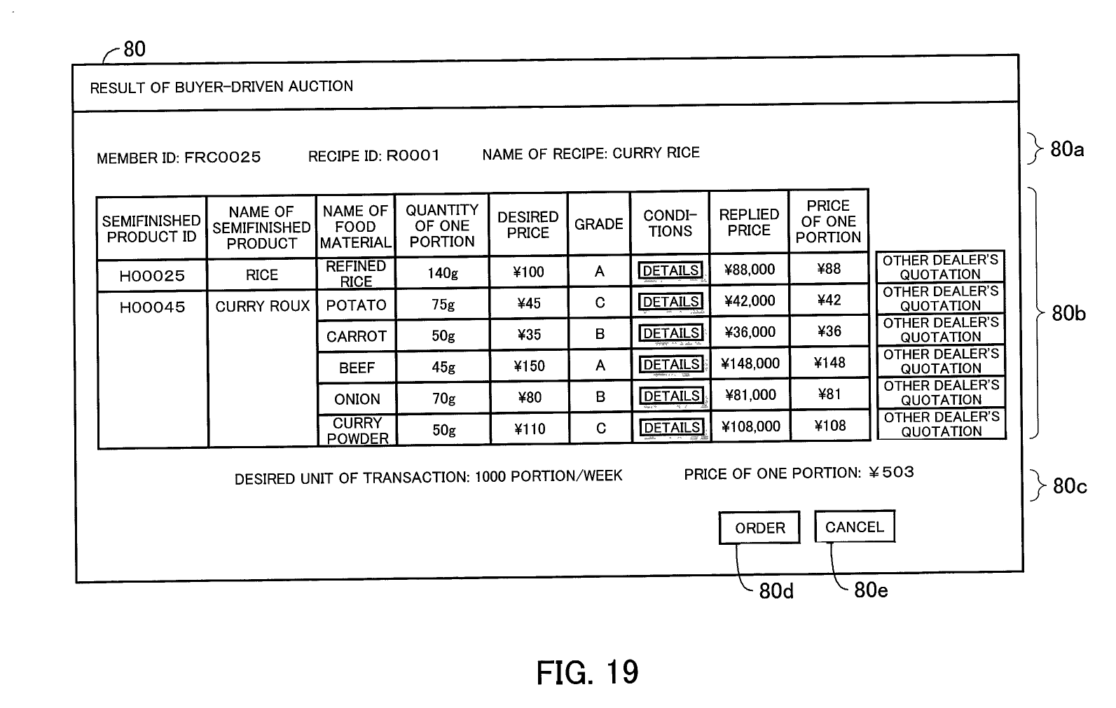

The sellers having received the electronic mail can access a page showing the result of the buyer-driven auction shown in FIG. 19 by clicking the URL “http//www.shokuzai.com/T0041/” attached to the electronic mail.

In a screen 80 shown in FIG. 19, a member ID, a recipe ID, and the name of a recipe are shown in a region 80a. Further, information as to respective food materials, prices responded as the result of the buyer-driven auction, and a portion price as a price per portion are displayed in a region 80b. Buttons of “other dealer's quotation” are displayed at the right end of the region 80b so that they are pressed when quotations of other dealers are referred to. Further, “price of one portion” as a price of one portion of a finished produce which is obtained by adding the one portion prices of the respective raw materials is shown in a region 80c.

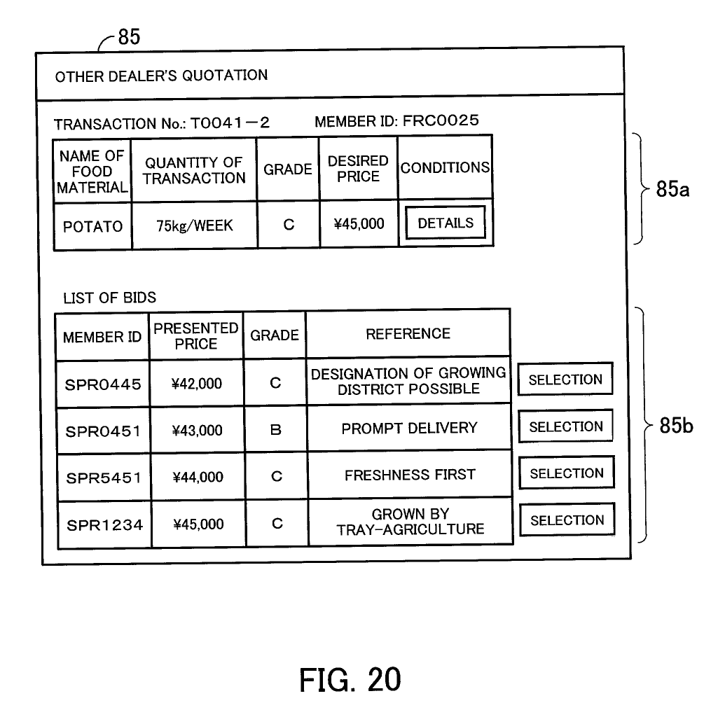

It should be noted that since a successful bidder is determined based on only a price, when other conditions (for example, a grade and the like) are to be referred to, an other dealer's quotation button concerned is pressed. As an example, when other dealer's quotation is to be referred to as to potato, a screen 85 shown in FIG. 20 is displayed by pressing an other dealer's quotation button corresponding to potato. On the screen 85, the transaction conditions of the buyer for potato are displayed in a region 85a, and a list of bids is displayed in a region 85b.

In the example, the grade presented by the bidder of the cheapest bid price of ¥42,000 is “C”, whereas the grade presented by the bidder of the next cheapest bid price of ¥43,000 is “B”. When the buyer desires to make a transaction with the latter bidder, the buyer presses a selection button displayed on the right side of the second bidder.

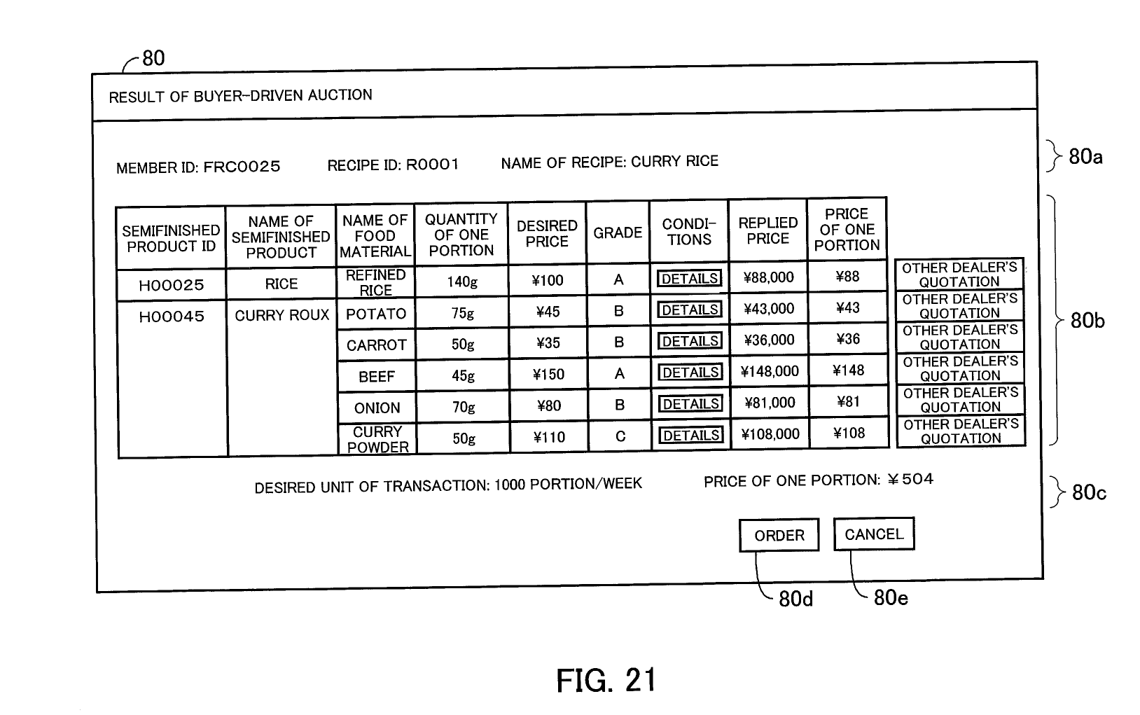

As a result, the displayed contents of potato and one portion price are changed as shown in FIG. 21.

It should be noted that when the buyer places orders for a plurality of foods, a screen showing the result of a buyer-driven auction carried out to each food is displayed. In such cases, when the same food material is included in the respective foods and the same food material used in the respective foods is integrally put up for an auction (a case of the above-mentioned onion), the transaction price of the food material used in each food is obtained by dividing the total amount of the price applied to the food material by the ratio of the quantity of transaction of the each food. Note that when a food material which is common to a plurality of foods is included and a seller of the food material is changed on a screen as the result of the auction of one of the foods, the result of change must be reflected to the other foods. In such a case, it is sufficient to link the screens of the buyer-driven auctions of the respective foods to each other.

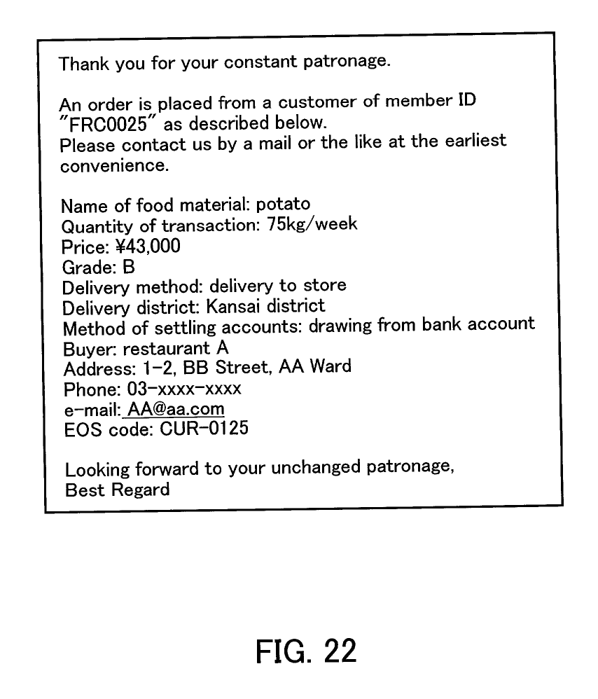

When an order button 80d is pressed after a seller is determined, an electronic mail as shown in FIG. 22 is transmitted to the selected seller and an order is placed with the selected seller. In the example of FIG. 22, a massage is displayed which shows that an order is placed with the seller together with the name of a food material, information as to transaction conditions such as a quantity of transaction, and the like, a buyer's name, a buyer's address, a phone number, and an electronic mail address. Further, an easy ordering system (EOS) code “CUR-0125” applied to the transaction is shown below the electronic mail address. Accordingly, parties concerned with the transaction can smoothly place and receive orders by using the EOS code in the transactions carried out subsequently.

Note that when the buyer gets quotations for a plurality of foods including a common food material, the buyer must place an order for the food material at that time when an order is placed for all the foods including the common food material.

According to the above-mentioned embodiment, when the name of the finished product is input on the screen 50 shown in FIG. 4, the raw materials necessary to the finished products are listed up and the raw materials in the list can be appropriately changed when necessary, which permits an order to be simply placed for the raw materials of the finished product.

In the above embodiment, since the unit prices of the respective raw materials and the unit price of the finished product are forecast referring to past transactions, the buyer can find the approximate prices thereof when the buyer makes an inquiry for them.

In the above-mentioned embodiment, when a plurality of dealers handling a predetermined raw material are available, the buyer determines the price of the predetermined raw material by a buyer-driven auction, which permits the buyer to conduct a transaction at a price that is advantageous to the buyer by the introduction of a principle of competition.

When the buyer selects a seller as a result of the buyer-driven auction, the buyer can refer to the contents of the quotations of other dealers, which permits the buyer to select the seller referring to conditions other than a price.

When orders are placed for raw materials used in a plurality of foods, orders for a raw material commonly used in the foods are integrated and handled as a single order, which can reduce a load applied to a system by decreasing the number of orders as well as which permits a buyer to conduct a transaction under advantageous conditions by increasing the quantity of the raw material ordered.

Further, menu information such as the raw materials constituting the respective menus of a buyer can be kept in secret because what is presented to sellers is only the information of the raw materials which are handled by sellers.

Next, an example of processing executed in the embodiment will be described below.

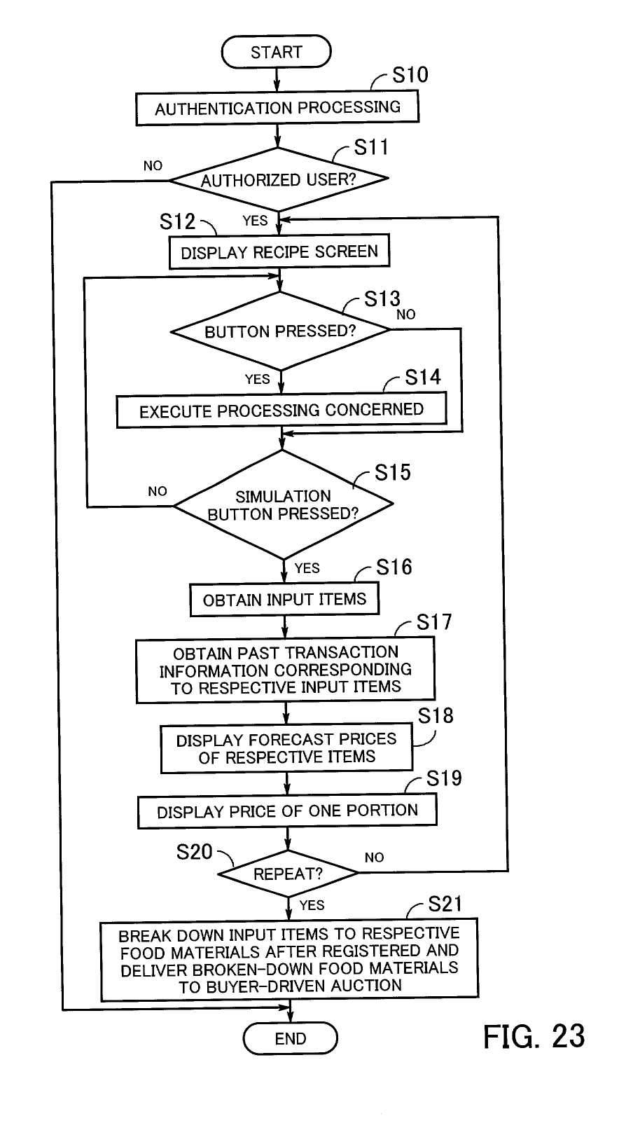

FIG. 23 is a flowchart explaining an example of processing executed when a buyer inputs a food material. When the flowchart is started, the following processing will be executed.

At step S10, the CPU 30a subjects a buyer to authentication processing by comparing the information transmitted from the client of the buyer with the table shown in FIG. 3.

At step S11, when it is confirmed that the buyer is an authorized user as a result of the authentication processing, the CPU 30a goes to step S12, otherwise, the CPU 30a finishes the processing.

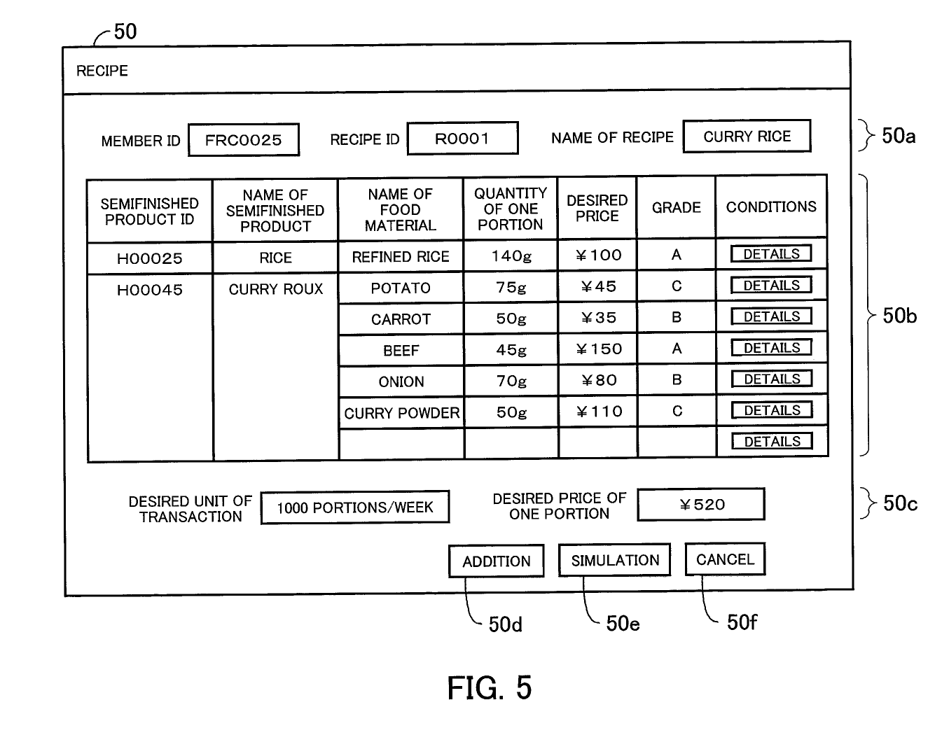

At step S12, the CPU 30a causes the screen 50 of the recipe shown in FIG. 5 to be displayed on the display device of the client.

At step S13, the CPU 30a determines whether or not a predetermined button is pressed on the screen 50. When it is pressed, the CPU 30a goes to step S14, otherwise, the CPU 30a goes to step S15.

At step S14, the CPU 30a executes processing corresponding to the pressed button.

At step S15, the CPU 30a determines whether or not the simulation button 50e is pressed. When it is pressed, the CPU 30a goes to step S16, otherwise, the CPU 30a returns to step S13.

At step S16, the CPU 30a obtains the input items which have been input on the screen 50.

At step S17, the CPU 30a obtains past transaction information corresponding to the respective input items from the HDD 30d.

At step S18, the CPU 30a calculates the forecast price of each food material from the transaction information obtained at step S17, transmits the forecast price to a client which requested it and causes the client to display the forecast price.

At step S19, the CPU 30a transmits a presumed price of one portion, which can be obtained by adding the forecast prices of the respective food materials, to the client and causes the client to display the presumed price.

At step S20, the CPU 30a determines whether or not the simulation is to be repeated, and when the simulation is to be repeated, the process returns to step S12, otherwise, the process goes to step S21. Specifically, when the return button 60d is pressed on the screen 60 shown in FIG. 8, the process returns to step S12, whereas when the transmission button 60e is pressed thereon, the process goes to step S21.

At step S21, after the input items are registered in the HDD 30d, the CPU 30a breaks down the input items to respective food materials and sends the broken down input items to a program for executing a buyer-driven auction.

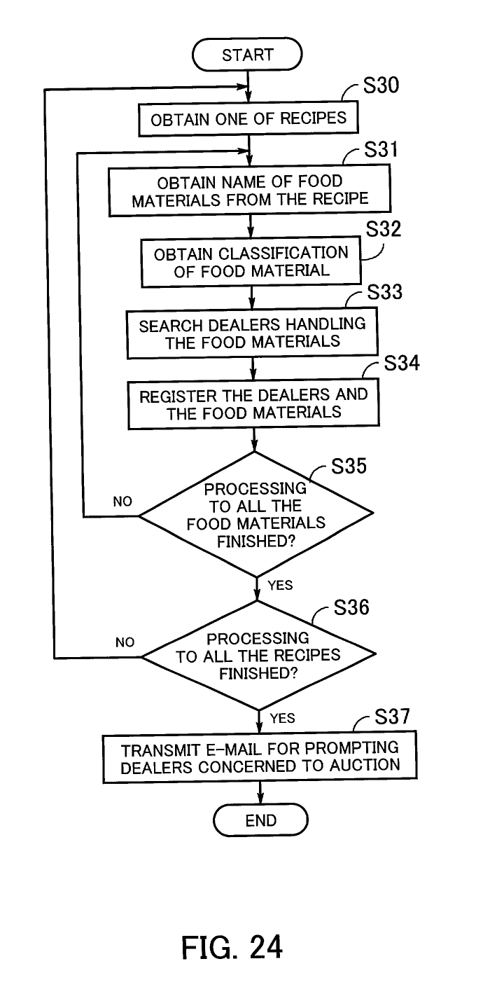

Next, processing for transmitting an electronic mail for prompting the dealers which handle the food materials shown on a recipe to the buyer-driven auction will be explained with reference to FIG. 24. It should be noted that the flowchart of FIG. 24 assumes a case where the buyer creates a plurality of recipes. When the flowchart is started, the following processing will be executed.

At step S30, the CPU 30a obtains one recipe from the HDD 30d.

At step S31, the CPU 30a obtains the name of one food material from the recipe.

At step S32, the CPU 30a obtains the food material classification of the food material.

At step S33, the CPU 30a specifies the dealers which handle the food material referring to the tables shown in FIGS. 12 and 13.

At step S34, the CPU 30a registers the obtained dealers and food material in the RAM 30c.

At step S35, the CPU 30a determines whether or not the processing has been finished to all the food materials, and when it has been finished to all the food materials, the process goes to step S36, otherwise the process returns to step S31 so as to repeat the same processing.

At step S36, the CPU 30a determines whether or not the processing has been finished to all the recipes, and when it has been finished to all the recipes, the process goes to step S37, otherwise the process returns to step S30.

At step S37, the CPU 30a transmits an electronic mail (refer to FIG. 14) for prompting the dealers which are registered in the RAM 30c to the buyer-driven auction.

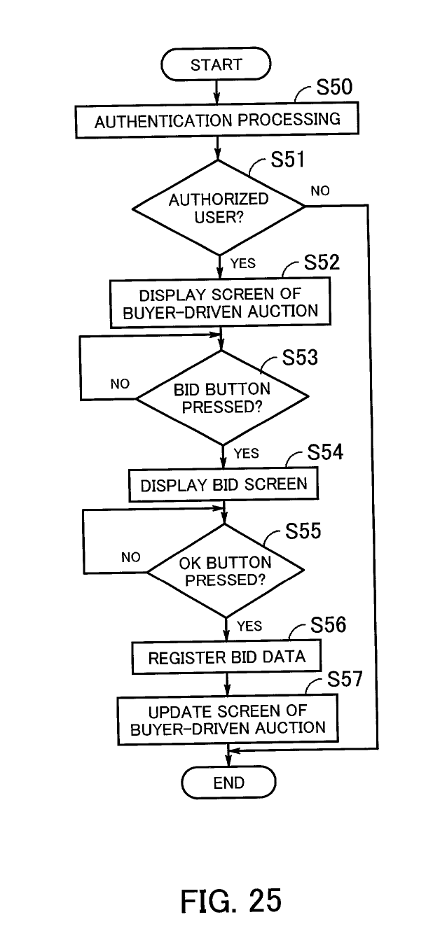

Next, processing as to the buyer-driven auction will be described with reference to FIG. 25.

When the flowchart of FIG. 25 is started, the following processing will be executed.

At step S50, the CPU 30a subjects a seller accessed to the transaction support apparatus 30 to authentication processing.

At step S51, when the CPU 30a determines that the seller is an authorized user as a result of the authentication processing at step S50, the process goes to step S52, otherwise, the processing is finished.

At step S52, the CPU 30a causes the screen 70 of the buyer-driven auction as shown in FIG. 15 to be displayed on the display device of a client.

At step S53, the CPU 30a determines whether or not a bid button 70c is pressed, and when the bid button 70c is pressed, the process goes to step S54, otherwise the CPU 30a repeats the same processing.

At step S54, the CPU 30a causes the bid screen 75 as shown in FIG. 16 to be displayed on the display device of the client.

At step S55, the CPU 30a determines whether or not the OK button 75c is pressed, and when the OK button 75c is pressed, the process goes to step S56, otherwise, the CPU 30a repeats the same processing.

At step S56, the CPU 30a registers the bid data input on the bid screen 75 shown in FIG. 16 in the HDD 30d.

At step S57, the CPU 30a updates the screen 70 of the buyer-driven auction in accordance with a result of the bid executed.

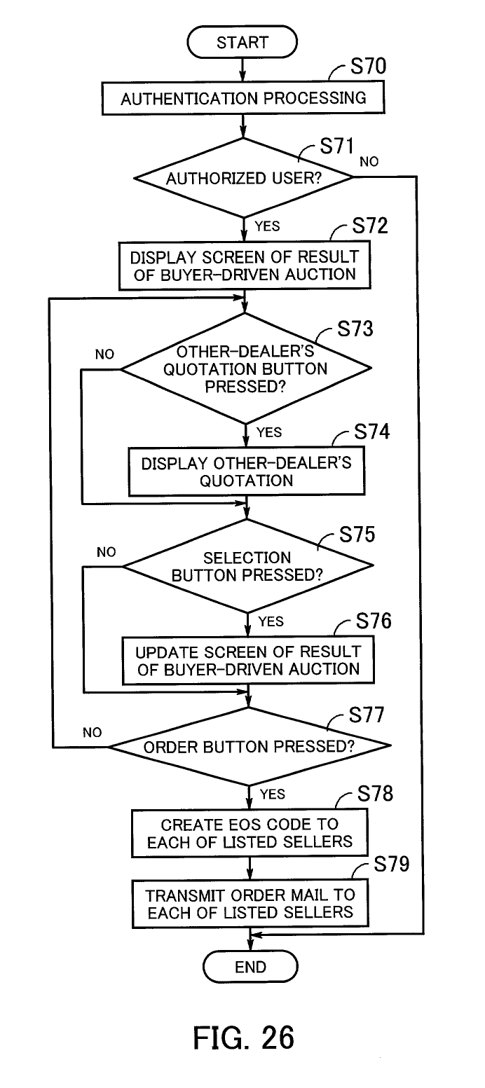

Next, an example of processing for placing an order based on a result of the bid will be explained referring to FIG. 26. When the flowchart of FIG. 26 is started, the following processing steps will be executed.

At step S70, the CPU 30a subjects a buyer accessed to the transaction support apparatus 30 to authentication processing.

At step S71, when the CPU 30a determines that the buyer is an authorized user as a result of the authentication processing at step S70, the process goes to step S72, otherwise, the processing is finished.

At step S72, the CPU 30a transmits a screen 80 of a result of the buyer-driven auction as shown in FIG. 19 to the client of the buyer and causes the client to display the screen 80.

At step S73, the CPU 30a determines whether or not an other dealer's quotation button is pressed, and when the other dealer's quotation button is pressed, the process goes to step S74, otherwise, the process goes to step S75.

At step S74, the CPU 30a transmits the screen 85 of the other dealer's quotation as shown in FIG. 20 to the client of the buyer and causes the client to display the screen 85.

At step S75, the CPU 30a determines whether or not a selection button is pressed on the screen 85 of the other dealer's quotation, and when the selection button is pressed, the process goes to step S76, otherwise the process goes to step S77.

At step S76, the CPU 30a updates the screen 80 of a result of the buyer-driven auction in accordance with the content selected at step S75.

At step S77, the CPU 30a determines whether or not the order button 80d is pressed, and when the order button 80d is pressed, the process goes to step S78, otherwise, the process returns to step S73 and repeats the same processing.

At step S78, the CPU 30a creates a EOS code to each of the listed sellers.

At step S79, the CPU 30a transmits an order mail to each of the listed sellers.

The functions explained in the embodiment can be realized by the above processing.

It should be noted that while the above embodiment explains such a case that the finished product is the food and the raw materials are food materials as an example, the present invention is not limited to the case. For example, the present invention can handle a chemical product as the finished product and chemicals as raw materials.

Finally, the above processing functions can be realized by a computer. In that case, the contents of processing executed by the functions that are to be provided with the transaction support apparatus are described in a program recorded on a recording medium, and the computer can realize the above processing by executing the program. A magnetic recording device, a semiconductor device and the like can be exemplified as the recording medium that can be read by the computer. The program can be put on the market by being stored in a portable recording medium such as a compact disc read only memory (CD-ROM), a floppy disc and the like. Otherwise, the program can be transferred to other computer through a network by being stored in a memory device of a computer connected through the network. When the program is executed by the computer, it can be executed by being stored in a hard disc device of the computer and loaded on a main memory.

As described above, the present invention provides the transaction support method on the server side for supporting commodity transactions executed between a buyer and sellers through a network, the transaction support method including the finished product designating step for receiving the designation of a finished product from the buyer; the raw material referring step for obtaining information as to raw materials constituting the finished product based on information as to the finished product and information as to the raw materials constituting the finished product with respect to the finished product designated by the finished product designating step; the inquiry step for making inquiries to the sellers about the raw materials obtained at the raw material referring step; and the presenting step for presenting a result of the inquiry executed at the inquiry step to the sellers. Accordingly, it is possible to specify the raw materials constituting the finished product and to make an inquiry to dealers concerned by designating only the finished product.

Further, the present invention provides the transaction support method on the client side for supporting commodity transactions executed between a buyer and sellers through a network, the transaction support method including the finished product designating step for designating a finished product composed of a plurality of raw materials; the raw material change step for changing the kinds or the quantities of raw materials constituting the finished product as necessary; and the transmission step for transmitting information as to the raw materials the kinds or the quantities of which have been changed to a server side. Accordingly, it is possible to simply notify raw materials, to which an inquiry is issued, to a server supporting transaction.

The foregoing is considered as illustrative only of the principles of the present invention. Further, since numerous modifications and changes will readily occur to those skilled in the art, it is not desired to limit the invention to the exact construction and applications shown and described, and accordingly, all suitable modifications and equivalents may be regarded as falling within the scope of the invention in the appended claims and their equivalents.

What is claimed is:

1. A transaction support method on a server side for supporting commodity transactions executed between a buyer and sellers through a network comprising:
a finished product designating step for receiving the designation of a finished product from the buyer;
a raw material referring step for obtaining information as to raw materials constituting the finished product based on information as to the finished product and information as to the raw materials constituting the finished product with respect to the finished product designated at said finished product designating step;
an inquiry step for making inquiries to the sellers about the raw materials obtained at said raw material referring step; and
a presenting step for presenting a result of the inquiry executed at said inquiry step to the sellers.

2. A transaction support method according to claim 1, further comprising a raw material change step for changing the kinds or the quantities of the raw materials constituting the finished product.

3. A transaction support method according to claim 1, further comprising:
a raw material classifying step for classifying the information as to the raw materials obtained at said raw material referring step to respective sellers concerned; and
a transaction condition obtaining step for obtaining transaction conditions that are obtained as a result of the inquiry made at said inquiry step from the respective sellers,
wherein said presenting step integrates the transaction conditions of the respective sellers obtained at said transaction condition obtaining step and presents the integrated transaction conditions to the buyer.

4. A transaction support method according to claim 1, further comprising an auction step for determining transaction conditions by an auction when a plurality of sellers exist for a predetermined raw material.

5. A transaction support method according to claim 1, further comprising:
a transaction result information storing step for storing information as to a result of transaction; and
a transaction condition forecast step for forecasting the transaction conditions of the respective raw materials with reference to the information of the result of past transactions stored at said transaction result information storing step before executing the inquiry at said inquiry step.

6. A transaction support method according to claim 1, wherein, at said inquiry step, the quantities of the respective raw materials are calculated from the number of the finished product to be produced and said inquiry is executed as a result of the calculation.

7. A transaction support method according to claim 1, wherein, at said presenting step, the unit price of the finished product is calculated from the prices of the respective raw materials obtained as a result of the inquiry executed at said inquiry step and the thus calculated unit price of the finished product is presented.

8. A transaction support method according to claim 1, further comprising an identification code generating step for generating an identification code that is used when transactions are executed to the respective sellers when the transactions are established.

9. A transaction support apparatus for supporting commodity transactions executed between a buyer and sellers through a network comprising:
finished product designating means for receiving the designation of a finished product from the buyer;
raw material referring means for obtaining information as to raw materials constituting the finished product based on information as to the finished product and information as to the raw materials constituting the finished product with respect to the finished product designated by said finished product designating means;
inquiry means for making inquiries to the sellers about the raw materials obtained by said raw material referring means; and
presentation means for presenting a result of the inquiry executed by said inquiry means to the sellers.

10. A transaction support method on a client side for supporting commodity transactions executed between a buyer and sellers through a network comprising:
a finished product designating step for designating a finished product composed of a plurality of raw materials;
a raw material change step for changing the kinds or the quantities of raw materials constituting the finished product as necessary; and
a transmission step for transmitting information as to the raw materials the kinds or the quantities of which have been changed to a server side.
